(19) United States
(12) Patent Application Publication
(10) Pub. No.: US 2023/0276287 A1
(43) Pub. Date: Aug. 31, 2023

(54) TERMINAL, RADIO COMMUNICATION METHOD, AND BASE STATION

(71) Applicant: NTT DOCOMO, INC., Tokyo (JP)

(72) Inventors: Yuki Matsumura, Tokyo (JP); Satoshi Nagata, Tokyo (JP); Jing Wang, Beijing (CN); Lan Chen, Beijing (CN)

(73) Assignee: NTT DOCOMO, INC., Tokyo (JP)

(21) Appl. No.: 18/043,636

(22) PCT Filed: Sep. 3, 2020
(86) PCT No.: PCT/JP2020/033483

§ 371 Date: Mar. 1, 2023

(51) Int. Cl. H04W 24/10

(52) U.S. Cl. CPC H04W 24/10

(57) ABSTRACT

A terminal according to an aspect of the present disclosure includes a control section that determines, for a group, regarding a channel state information (CSI) report including a plurality of resource indicators and measurement results respectively corresponding to the plurality of resource indicators, at which position in the CSI report each of the resource indicators regarding which panel is to be included, based on whether or not signals for the plurality of resource indicators corresponding to a same group can be simultaneously received and the measurement results for each panel, and a transmitting section that transmits the CSI report. According to an aspect of the present disclosure, a CSI report related to a group based beam report can be suitably used.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+(plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In Rel-15 and Rel-16 NR, a UE for which a group based beam report is configured enabled can report only two different beam indices regarding each report configuration. Thus, for Rel. 17, enhancements related to beam management regarding a user terminal (User Equipment (UE)) including a plurality of panels (multi-panel), a plurality of transmission/reception points (multi-Transmission/Reception Point (TRP)), and the like have been under study.

However, when the enhancements related to beam management are made, how to configure a CSI report has not been studied yet. Unless this is clarified, appropriate communication between the TRP and the UE cannot be performed, and communication throughput may be deteriorated.

In view of this, the present disclosure has one object to provide a terminal, a radio communication method, and a base station with which a CSI report related to a group based beam report can be suitably used.

### Solution to Problem

A terminal according to an aspect of the present disclosure includes a control section that determines, for each group, regarding a channel state information (CSI) report including a plurality of resource indicators and measurement results respectively corresponding to the plurality of resource indicators, at which position in the CSI report each of the plurality of resource indicators regarding which panel is to be included, based on whether or not signals for the plurality of resource indicators corresponding to a same group can be simultaneously received and the measurement results for each panel, and a transmitting section that transmits the CSI report.

### Advantageous Effects of Invention

According to an aspect of the present disclosure, a CSI report related to a group based beam report can be suitably used.

### BRIEF DESCRIPTION OF DRAWINGS

FIGS. 1A and 1B are each a diagram to show an example of an RRC information element related to a CSI report configuration and a CSI resource configuration.

FIGS. 2A and 2B are each a diagram to show an example of an RRC information element related to an NZP CSI-RS resource set and a CSI-SSB resource set.

FIG. 3 is a diagram to show an example of an RRC information element related to a TCI state.

FIG. 4 is an extract of an RRC information element “CSI-ReportConfig.”

FIG. 5 is a diagram to show an example of a CSI report according to Rel-15 NR.

FIG. 6 is a diagram to show an example of a beam use environment assumed regarding a multiple group based beam report.

FIG. 7 is a diagram to show an example of the CSI report of mode 1 of the multiple group based beam report.

FIG. 8 is a diagram to show an example of the CSI report of mode 2 of the multiple group based beam report.

FIG. 9 is a diagram to show an example of measurement results respectively corresponding to the best RSs in respective TRPs and a plurality of reception panels.

FIGS. 10A and 10B are each a diagram to show an example in which mode 1 of the multiple group based beam report according to embodiment 1-2 is applied.

FIG. 11 is a diagram to show an example of the CSI report of mode 2 of the multiple group based beam report according to embodiment 2-1.

FIG. 12 is a diagram to show an example of a schematic structure of a radio communication system according to one embodiment.

FIG. 13 is a diagram to show an example of a structure of a base station according to one embodiment.

FIG. 14 is a diagram to show an example of a structure of a user terminal according to one embodiment.

FIG. 15 is a diagram to show an example of a hardware structure of the base station and the user terminal according to one embodiment.

### DESCRIPTION OF EMBODIMENTS

### (CSI)

In NR, a UE measures a channel state by using a reference signal (or resources for the reference signal), and feeds back (reports) channel state information (CSI) to a network (for example, a base station).

The UE may measure the channel state by using at least one of a channel state information reference signal (CSI-RS), a synchronization signal/broadcast channel (Synchronization Signal/Physical Broadcast Channel (SS/PBCH)) block, a synchronization signal (SS), a demodulation reference signal (DMRS), and the like.

A CSI-RS resource may include at least one of a non-zero power (NZP) CSI-RS resource, a zero power (ZP) CSI-RS resource, and a CSI interference measurement (CSI-IM) resource.

A resource for measuring a signal component for the CSI may be referred to as a signal measurement resource (SMR) or a channel measurement resource (CMR). The SMR (CMR) may include, for example, an NZP CSI-RS resource, an SSB, and the like for channel measurement.

A resource for measuring an interference component for the CSI may be referred to as an interference measurement resource (IMR). The IMR may include, for example, at least one of an NZP CSI-RS resource, an SSB, a ZP CSI-RS resource, and a CSI-IM resource for interference measurement.

The SS/PBCH block is a block including a synchronization signal (for example, a primary synchronization signal (PSS) or a secondary synchronization signal (SSS)) and a PBCH (and a corresponding DMRS), and may be referred to as an SS block (SSB) or the like.

Note that the CSI may include at least one of a channel quality indicator (CQI), a precoding matrix indicator (PMI), a CSI-RS resource indicator (CRI), an SS/PBCH block resource indicator (SSBRI), a layer indicator (LI), a rank indicator (RI), an L1-RSRP (reference signal received power in layer 1 (Layer 1 Reference Signal Received Power)), L1-RSRQ (Reference Signal Received Quality), an L1-SINR (Signal to Interference plus Noise Ratio), an L1-SNR (Signal to Noise Ratio), and the like.

The CSI may include a plurality of parts. CSI part 1 may include information (for example, the RI) having relatively a small number of bits. CSI part 2 may include information (for example, the CQI) having relatively a large number of bits, such as information determined based on CSI part 1.

The CSI may be categorized into some CSI types. Depending on the CSI type, an information type, size, and the like to be reported may be different. For example, a CSI type that is configured for performing communication using a single beam (also referred to as type 1 (type I) CSI, CSI for single beam, or the like) and a CSI type that is configured for performing communication using a multi-beam (also referred to as type 2 (type II) CSI, CSI for multi-beam, or the like) may be defined. The usage of the CSI type is not limited to these.

As a feedback method of the CSI, a periodic CSI (P-CSI) report, an aperiodic CSI (A-CSI) report, a semi-persistent CSI (SP-CSI) report, and the like have been under study.

The UE may receive reporting of CSI measurement configuration information by using higher layer signaling, physical layer signaling, or a combination of these.

In the present disclosure, the higher layer signaling may be, for example, any one of Radio Resource Control (RRC) signaling, Medium Access Control (MAC) signaling, broadcast information, and the like, or a combination of these.

The MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

The physical layer signaling may be, for example, downlink control information (DCI).

The CSI measurement configuration information may be configured by using, for example, an RRC information element “CSI-MeasConfig.” The CSI measurement configuration information may include CSI resource configuration information (RRC information element “CSI-ResourceConfig”), CSI report configuration information (RRC information element “CSI-ReportConfig”), and the like. The CSI resource configuration information is related to resources for CSI measurement, and the CSI report configuration information is related to how the UE carries out the CSI reporting.

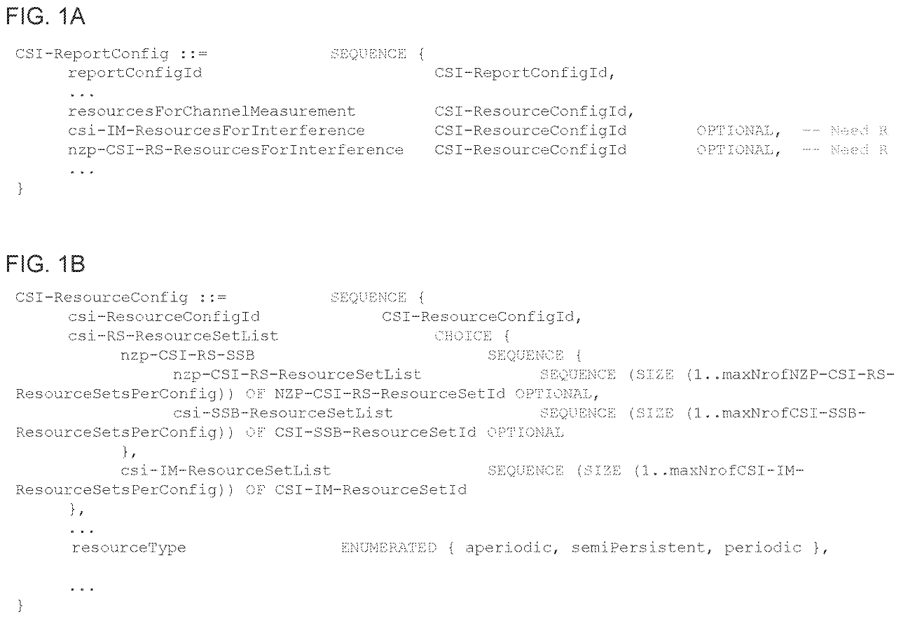

FIGS. 1A and 1B are each a diagram to show an example of an RRC information element related to a CSI report configuration and a CSI resource configuration. In the present example, an extract of fields (which may be referred to as parameters) included in the information element is shown. FIGS. 1A and 1B are described by using the notation of ASN.1 (Abstract Syntax Notation One). Note that figures related to other RRC information elements (or RRC parameters) in the present disclosure are described with a similar notation as well.

As shown in FIG. 1A, the CSI report configuration information (“CSI-ReportConfig”) includes resource information for channel measurement (“resourcesForChannelMeasurement”). The CSI report configuration information may also include resource information for interference measurement (for example, NZP CSI-RS resource information for interference measurement (“nzp-CSI-RS-ResourcesForInterference”), CSI-IM resource information for interference measurement (“csi-IM-ResourcesForInterference”), or the like). These pieces of resource information each correspond to an ID (Identifier) of the CSI resource configuration information (“CSI-ResourceConfigId”).

Note that, regarding the ID of the CSI resource configuration information (which may be referred to as a CSI resource configuration ID) corresponding to each piece of resource information, one or a plurality of IDs may be the same value or may be values different from each other.

As shown in FIG. 1B, the CSI resource configuration information (“CSI-ResourceConfig”) may include a CSI resource configuration information ID, CSI-RS resource set list information (“csi-RS-ResourceSetList”), a resource type (“resourceType”), and the like. The CSI-RS resource set list may include at least one of information of the NZP CSI-RS and the SSB for measurement (“nzp-CSI-RS-SSB”) and CSI-IM resource set list information (“csi-IM-ResourceSetList”).

The resource type represents a behavior of the time domain of the resource configuration, and “aperiodic,” “semi-persistent,” and “periodic” may be configured. For example, the CSI-RSs corresponding to the above may be referred to as an A-CSI-RS, an SP-CSI-RS, and a P-CSI-RS, respectively.

Note that the resources for channel measurement may be, for example, used for calculation of the CQI, the PMI, the L1-RSRP, and the like. The resources for interference measurement may be used for calculation of the L1-SINR, the L1-SNR, and the L1-RSRQ, as well as an indicator related to other interference.

When interference measurement is performed with CSI-IM, each CSI-RS for channel measurement may be associated with the CSI-IM resource from the point of view of resources, based on the order of the CSI-RS resources and the CSI-IM resources in a corresponding resource set.

“nzp-CSI-RS-SSB” may include NZP CSI-RS resource set list information (“nzp-CSI-RS-ResourceSetList”) and SSB resource set list information for CSI measurement (“csi-SSB-ResourceSetList”). These pieces of list information each correspond to one or more NZP CSI-RS resource set IDs (“NZP-CSI-RS-ResourceSetId”) and CSI-SSB resource set IDs (“CSI-SSB-ResourceSetId”), and may be used for identifying resources of a measurement target.

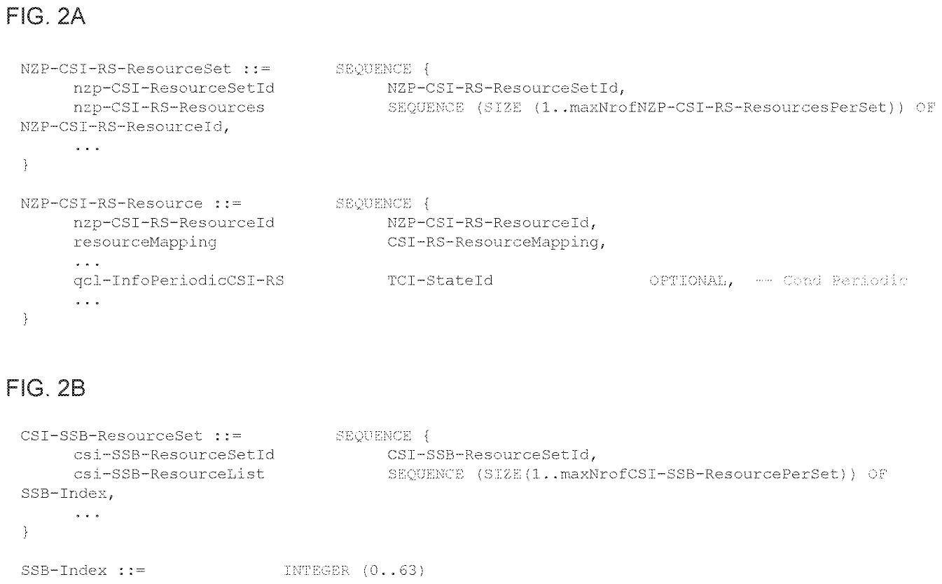

FIGS. 2A and 2B are each a diagram to show an example of an RRC information element related to an NZP CSI-RS resource set and a CSI-SSB resource set.

As shown in FIG. 2A, NZP CSI-RS resource set information (“NZP-CSI-RS-ResourceSet”) includes an NZP CSI-RS resource set ID and one or more NZP CSI-RS resource IDs (“NZP-CSI-RS-ResourceId”).

The NZP CSI-RS resource information (“NZP-CSI-RS-Resource”) may include an NZP CSI-RS resource ID, and an ID (“TCI-stateId”) of a transmission configuration indication state (TCI state). The TCI state will be described below.

As shown in FIG. 2B, CSI-SSB resource set information (“CSI-SSB-ResourceSet”) includes a CSI-SSB resource set ID and one or more pieces of SSB index information (“SSB-Index”). The SSB index information is, for example, an integer of 0 or greater or 63 or less, and may be used for identifying the SSB in an SS burst.

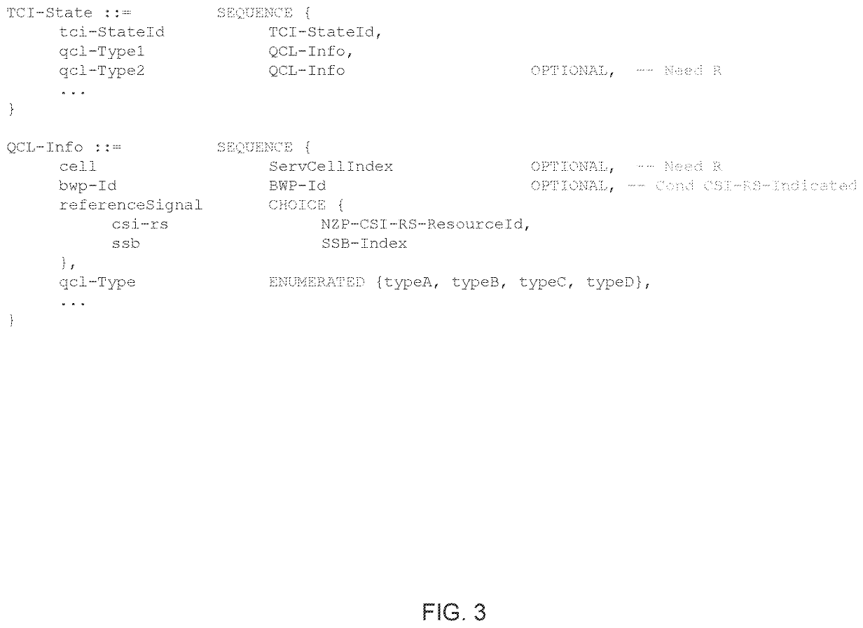

FIG. 3 is a diagram to show an example of an RRC information element related to the TCI state.

The TCI state is information related to quasi-co-location (QCL) of a channel or a signal, and may also referred to as a spatial reception parameter, spatial relation information (spatial relation info), or the like. The TCI state may be configured or specified for the UE for each channel or for each signal.

As shown in FIG. 3, TCI state information (“TCI-State”) may include a TCI state ID and one or more pieces of QCL information (“QCL-Info”). The QCL information may include at least one of information related to a reference signal of a QCL source (RS related information (“referenceSignal”)) and information indicating QCL type (QCL type information (“qcl-Type”)). The RS related information may include information such as an index of the RS (for example, the NZP CSI-RS resource ID or the SSB index), an index of the serving cell, and an index of a BWP (Bandwidth Part) at which the RS is located.

Regarding at least one of a signal and a channel (referred to as a signal/channel), the UE may control reception processing (for example, at least one of reception, demapping, demodulation, decoding, determination of a receive beam, and the like), transmission processing (for example, at least one of transmission, mapping, modulation, coding, determination of a transmit beam, and the like), and the like, based on the TCI state that corresponds to the TCI state ID associated with the signal/channel.

Note that, in the present disclosure, “A/B” may mean “at least one of A and B.”

As shown in FIG. 2A, regarding the P-CSI-RS, a related TCI state may be configured by RRC. Note that, regarding the P-CSI-RS, the SP-CSI-RS, and the A-CSI-RS, a related TCI state may be determined based on higher layer signaling, physical layer signaling, or a combination of these.

### (Beam Management)

In Rel-15 NR, a method of beam management (BM) has been under study. In the beam management, performing beam selection based on L1-RSRP reported by the UE has been under study. To change (switch) beams of a certain signal/channel may correspond to changing at least one of the TCI state of the signal/channel and QCL assumption.

The UE may report (transmit) measurement results for beam management by using an uplink control channel (Physical Uplink Control Channel (PUCCH)) or an uplink shared channel (Physical Uplink Shared Channel (PUSCH)). The measurement results may be, for example, the CSI including at least one of L1-RSRP, L1-RSRQ, L1-SINR, L1-SNR, and the like.

The measurement results (for example, the CSI) reported for beam management may be referred to as beam measurement, a beam measurement report, a beam report, beam report CSI, or the like.

The CSI measurement for beam report may include interference measurement. The UE may measure channel quality, interference, or the like by using the resources for CSI measurement and derive the beam report.

In the beam report, results of at least one of channel quality measurement and interference measurement may be included. Results of channel quality measurement may include, for example, L1-RSRP. Results of interference measurement may include an indicator related to L1-SINR, L1-SNR, L1-RSRQ, and other interference (for example, any indicator that is not L1-RSRP) or the like.

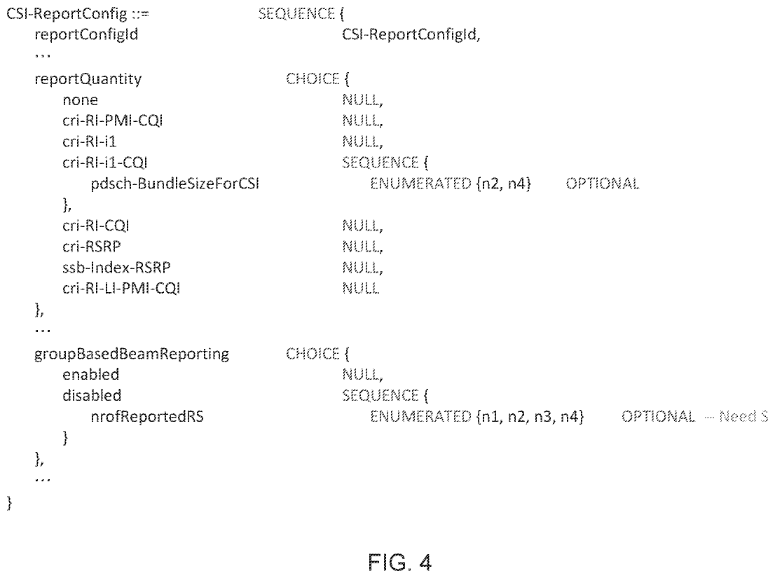

The CSI report configuration information in consideration of beam management according to NR at present will be described with reference to FIG. 4. FIG. 4 is an extract of the RRC information element “CSI-ReportConfig.” FIG. 4 extracts a different part of the CSI report configuration information (CSI-ReportConfig), the CSI report configuration information being the same as in FIG. 1A.

The CSI report configuration information may include “report quantity” (which may be represented as an RRC parameter “reportQuantity”) being information of a parameter reported with one report instance (for example, one piece of CSI). The report quantity is defined as a type of an ASN.1 object referred to as a “choice type (choice).” Thus, one of parameters (cri-RSRP, ssb-Index-RSRP, and the like) defined as the report quantity is configured.

The UE for which a higher layer parameter (for example, an RRC parameter “groupBasedBeamReporting” related to a group based beam report) included in the CSI report configuration information is configured disabled may include, regarding each report configuration (report setting), a different number of resource IDs (for example, SSBRIs or CRIs) for beam measurement of a higher layer parameter (for example, an RRC parameter “nrofReportedRS” indicating the number of RSs to be reported) included in the CSI report configuration information and measurement results (for example, L1-RSRP) corresponding to respective IDs in the beam report (one report instance).

The UE for which groupBasedBeamReporting is configured enabled may include, regarding each report configuration, two different resource IDs for beam measurement and two measurement results (for example, L1-RSRP) corresponding to respective IDs in the beam report. In other words, the UE for which groupBasedBeamReporting is configured enabled divides DL-RSs (for example, CSI-RSs) into two groups, and reports IDs and measurement values regarding superior RSs in the respective groups. Note that the two resources (CSI-RS resources, SSB resources) for beam measurement may be simultaneously received by the UE using one spatial domain reception filter, or may be simultaneously received by using a plurality of simultaneous spatial domain reception filters.

The NZP CSI-RS resource set information shown in FIG. 2A may include information related to repetition in resources in the resource set. The information related to the repetition may indicate ‘on’ or ‘off’, for example. Note that ‘on’ may be expressed as ‘enabled’ or ‘valid’, and ‘off’ may be expressed as ‘disabled’ or ‘invalid’.

For example, regarding the resource set for which the repetition is configured ‘on’, the UE may assume that the resources in the resource set have been transmitted using the same downlink spatial domain transmission filter. In this case, the UE may assume that the resources in the resource set have been transmitted using the same beam (for example, using the same beam from the same base station).

Regarding the resource set for which the repetition is configured ‘off’, the UE may perform such control that the UE is prohibited to assume (or need not assume) that the resources in the resource set have been transmitted using the same downlink spatial domain transmission filter. In this case, the UE may assume that the resources in the resource set are not transmitted using the same beam (have been transmitted using a different beam). In other words, regarding the resource set for which the repetition is configured ‘off’, the UE may assume that the base station performs beam sweeping.

In Rel-15 NR, out of the report quantity, cri-RSRP and ssb-Index-RSRP are related to beam management. The UE for which cri-RSRP is configured as the report quantity reports the CRI and the L1-RSRP corresponding to the CRI. The UE for which ssb-Index-RSRP is configured as the report quantity reports the SSBRI and the L1-RSRP corresponding to the SSBRI.

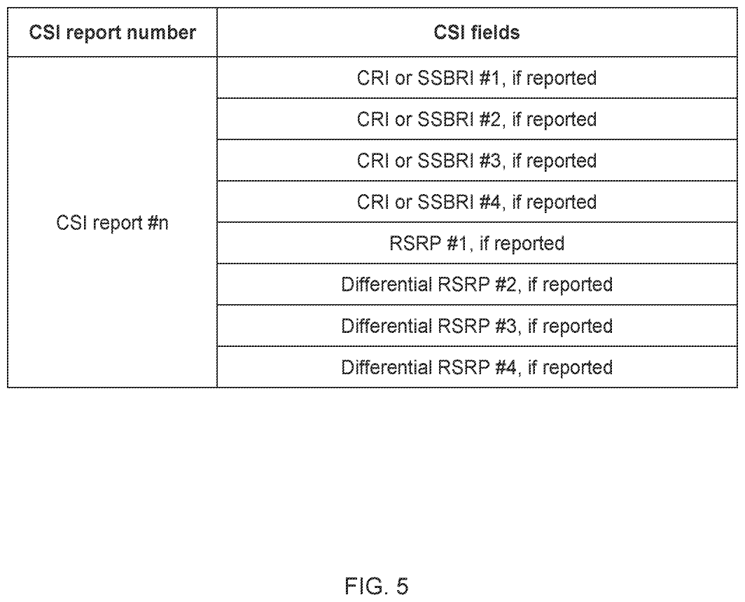

FIG. 5 is a diagram to show an example of the CSI report according to Rel-15 NR. FIG. 5 shows mapping order of CSI fields included in one CSI report (n-th CSI report #n) for a CSI/RSRP or SSBRI/RSRP report, which is defined in Table 6.3.1.1.2-8 of 3GPP TS 38.212 V15.7.0.

The CSI report of FIG. 5 may include one or more pairs of the CRI/SSBRI and the RSRP. The number of these pairs may be configured by using a higher layer parameter (for example, the RRC parameter “nrofReportedRS”) indicating the number of reference signal resources of a report target.

Regarding the L1-RSRP report, when nrofReportedRS is configured to 1 (‘n1’ as a value), RSRP #1 being a field of a certain number of bits (for example, m bits) indicating the L1-RSRP of the largest measurement value is included in the CSI report. In Rel-15 NR, m=7.

Regarding the L1-RSRP report, when nrofReportedRS is configured to greater than 1, or when groupBasedBeamReporting is configured enabled, the UE uses a differential L1-RSRP based report. Specifically, the UE includes RSRP #1 indicating the L1-RSRP of the largest measurement value and differential RSRP #k calculated with reference to the largest measurement value (for example, as a differential from the measurement value) regarding a k (k=2, 3, 4 in FIG. 5)-th largest L1-RSRP, in the same CSI report (reporting instance). Here, differential RSRP #k may be a field of bits (for example, n bits) less than the certain number. In Rel-15 NR, n=4.

Note that, when groupBasedBeamReporting is configured enabled, the UE includes RSRP #1 and differential RSRP #2 in the same CSI report.

CRI/SSBRI #k of FIG. 5 is a field indicating the CRI/SSBRI corresponding to RSRP #k or differential RSRP #k (included when RSRP #k or differential RSRP #k is reported).

Note that, in NR of Rel. 16 or later versions, nrofReportedRS may be a value of 4 or greater, or may be 4 or less. In the CSI report, four or more pairs of CRI/SSBRI and RSRP may be included. For example, m and n described above are not limited to 7 and 4, respectively.

In NR of Rel. 16 or later versions, L1-SINR report may be performed. In the L1-SINR report, such matters may be applied that the RSRP in the L1-RSRP report described above is replaced with the SINR. Note that, in this case, configurations/parameters for the SINR may be different from the configurations/parameters for the RSRP, and for example, nrofReportedRS above may be replaced with nrofReportedRSForSINR indicating the number of reference signal resources of a report target of the SINR.

### (Enhanced Group Based Beam Report)

For future radio communication systems (for example, Rel-17 NR), enhancements related to beam management (which may be referred to as, for example, beam report suitable to a plurality of TRPs, or enhanced group based beam report) regarding a user terminal (User Equipment (UE)) including a plurality of panels (multi-panel), a plurality of transmission/reception points (multi-Transmission/Reception Point (TRP)), and the like have been under study.

groupBasedBeamReporting described above enables reporting regarding two groups in one report, and is thus suitable for a case in which multi-TRP transmission, multi-panel reception, and the like are applied. For example, groupBasedBeamReporting can be used for reporting the best beam of TRP1 with RSRP #1 and the best beam of TRP2 as differential RSRP #2.

As described in the above, in Rel. 15 and Rel. 16, the UE for which the group based beam report is configured enabled can report only two different CRIs/SSBRIs (which may be replaced with beam indices) regarding each report configuration. Thus, for Rel. 17, increasing the number of groups that can be reported with the group based beam report to greater than two has been under study. For the sake of a more flexible report, configuration allowing for reporting of two or more CRIs/SSBRIs in the group has been under study as well.

The group based beam report using such a beam report (a beam report in which the number of groups related to the report is greater than two or two or more CRIs/SSBRIs are reported in the group related to the report) may be referred to as a multiple group based beam, an enhanced group based beam report, a group based beam report of Rel. 17, or the like (hereinafter referred to as a multiple group based beam report).

Regarding situations in which the multiple group based beam report is used, the following two modes may be considered:
Mode 1: The UE can simultaneously receive a plurality of beams respectively belonging to different groups.
Mode 2: The UE can simultaneously receive a plurality of beams belonging to the same group.

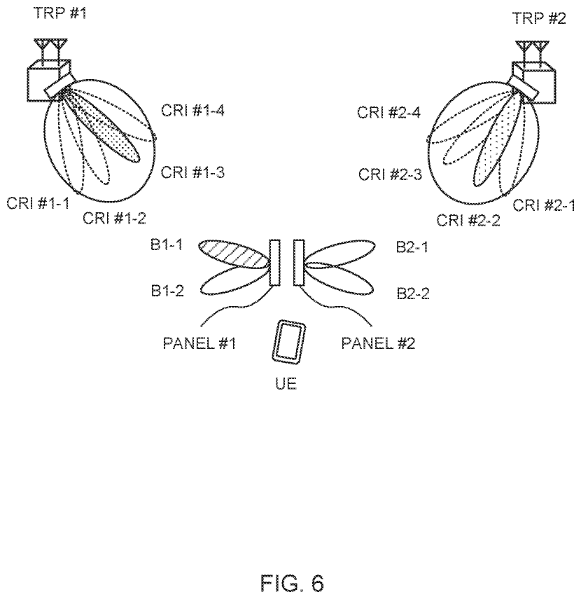

In the following, situations in which the multiple group based beam report is used will be described by taking an environment of FIG. 6 as an example. FIG. 6 is a diagram to show an example of a beam use environment assumed regarding the multiple group based beam report.

In FIG. 6, the UE measures resources of reference signals (CSI-RSs) transmitted from two TRPs (TRPs #1 and #2). The UE includes two panels (panels #1 and #2), each of which panel can form different beams (B1-1, B1-2, B2-1, and B2-2).

TRP #1 transmits the CSI-RS by using resources of CRI #1-1 to CRI #1-4 respectively corresponding to different beams. TRP #2 transmits the CSI-RS by using resources of CRI #2-1 to CRI #2-4 respectively corresponding to different beams. In the present disclosure, the beams of CRI #1-1 to CRI #1-4 may be interchangeably interpreted as transmit beams #1 to #4, respectively. In the present disclosure, the beams of CRI #2-1 to CRI #2-4 may be interchangeably interpreted as transmit beams #5 to #8, respectively.

Note that each TRP and the UE may transmit and receive respective beams by sweeping the beams (by using different times/frequencies), or may transmit and receive by simultaneously using some beams.

Note that FIG. 6 is merely an example, and for example, TRPs #1 and #2 may be interpreted as two panels (panels #1 and #2) of a certain TRP.

The RSRPs/SINRs corresponding to CRI #1-1 to CRI #1-4 may be expressed as RSRP/SINR #1-1 to RSRP/SINR #1-4, respectively. The RSRPs/SINRs corresponding to CRI #2-1 to CRI #2-4 may be expressed as RSRP/SINR #2-1 to RSRP/SINR #2-4, respectively.

Resources corresponding to a certain CRI may be hereinafter simply expressed as a certain CRI (for example, CRI #1-1 may mean CRI #1-1, or may mean resources corresponding to CRI #1-1).

In the present disclosure, description will be given based on an assumption that one resource configuration (which may be referred to as a reference signal (RS) configuration) corresponds to (is associated with) one TRP. The resource configuration corresponding to one TRP may correspond to, for example, at least one of CSI resource configuration information (“CSI-ResourceConfig”), a CSI-RS resource set list, an NZP CSI-RS resource set, and a CSI-SSB resource set.

For example, regarding FIG. 6, RRC configuration may be performed as follows. CSI report configuration #0 configured for the UE includes CSI resource configurations #0 and #1. CSI resource configuration #0 relates to resource set #0 (CSI-RS resource set #0), and in resource set #0, four CSI-RS resources corresponding to CRIs #1-1 to #1-4 are configured. CSI resource configuration #1 relates to resource set #1 (CSI-RS resource set #1), and in resource set #1, four CSI-RS resources corresponding to CRIs #2-1 to #2-4 are configured.

Note that, even when one resource configuration corresponds to (is associated with) a plurality of TRPs, the contents of the present disclosure may be applied.

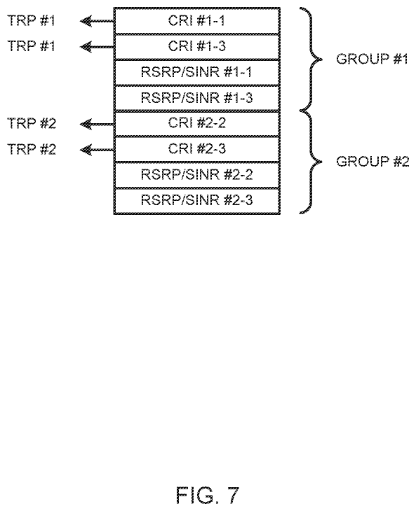

FIG. 7 is a diagram to show an example of the CSI report of mode 1 of the multiple group based beam report. In the example shown in FIG. 7, the UE selects beams from two TRPs #1 measured using panel #1, and selects beams from two TRPs #2 measured using panel #2. Note that, in the present example, the UE assumes that panel #1 relates to group #1 and panel #2 relates to group #2.

In the following, the number of measurement results of the CRIs and the number of elements in the configuration of the CSI report in the drawings of the present disclosure are merely examples, and are not limited to these numbers.

In this case, regarding group #1 (panel #1), the UE determines CRI #1-1 and CRI #1-3 as a report target, out of the CRIs of CSI resource configuration #0 related to TRP #1. Regarding group #2 (panel #2), the UE determines CRI #2-2 and CRI #2-3 as a report target, out of the CRIs of CSI resource configuration #1 related to TRP #2.

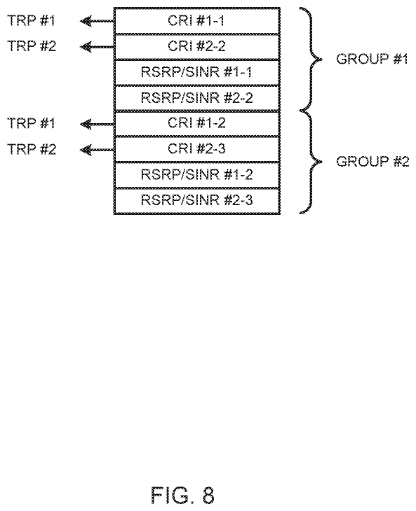

FIG. 8 is a diagram to show an example of the CSI report of mode 2 of the multiple group based beam report. In the example of FIG. 8, the UE selects, for each group, a beam from one TRP measured using panel #1 and a beam from another TRP measured using panel #2.

In this case, regarding group #1, the UE selects CRI #1-1 as a report target out of the CRIs corresponding to TRP #1 in reception panel #1, and CRI #2-2 as a report target out of TRP #2 different from TRP #1 in reception panel #2. Regarding group #2, the UE selects CRI #2-3 as a report target out of the CRIs corresponding to TRP #2 in reception panel #1, and CRI #1-2 as a report target out of TRP #1 different from TRP #2 in reception panel #2.

One of mode 1 and mode 2 described above may be supported by the UE, or both of them may be supported by the UE.

Incidentally, in the multiple group based beam report as described above, regarding how to configure the CSI report, specifically, regarding how to perform determination of a report target (beam/beam pair/panel) in each group, has not been fully studied yet. Unless this is clarified, communication throughput may be deteriorated.

Specifically, for example, regarding each RS/RS set configuration/TRP, how to perform determination (selection)/ordering of the panel(s) for measurement has not been fully studied yet. As specific examples to be studied, the following may be considered:
Method of determining the TRP/panel corresponding to a certain group in mode 1,
Regarding whether or not measurement results regarding another TRP not corresponding to a certain group can be reported by using a certain panel in mode 1,
Regarding ordering of a plurality of groups in mode 1,
Method of determining whether to include measurement results in a certain TRP/panel in a certain group in mode 2,
Regarding how to determine whether to include measurement results of a panel in use corresponding to a certain TRP and another panel in use corresponding to another TRP in a certain group in mode 2,
Regarding how to determine whether to include measurement results of a panel in use corresponding to a certain TRP and another panel in use corresponding to another TRP in a certain group and regarding the measurement results can be reported in mode 2,
Regarding ordering of a plurality of groups in mode 2.

Rules of beam determination/ordering in each group have not been fully studied yet either. For example, in the CSI report of mode 1 as shown in FIG. 7 described above, whether to map CRI #1-1 in group #1 prior to CRI #1-3 and how to perform determination thereof have not been fully studied yet. For example, in the CSI report of mode 2 as shown in FIG. 8 described above, whether to map CRI #1-1 in group #1 prior to CRI #2-2 and how to perform determination thereof have not been fully studied yet.

Note that, in order to simultaneously receive a plurality of beams, the UE may select a pair of CRIs (which may be referred to as a beam pair). The UE may assume that the beam pair is a combination of any of the CRIs in each group. The UE may assume that the beam pair is a combination of specific CRIs in each group.

In view of this, the inventors of the present invention came up with the idea of a CSI report configuration method suitable for the multiple group based beam report.

Embodiments according to the present disclosure will be described in detail with reference to the drawings as follows. The radio communication methods according to respective embodiments may each be employed individually, or may be employed in combination.

Note that, in the present disclosure, a panel (reception panel), an Uplink (UL) transmission entity, a TRP, a spatial relation, a control resource set (CORESET), a PDSCH, a codeword, a base station, an antenna port (for example, a demodulation reference signal (DMRS) port), an antenna port group (for example, a DMRS port group), a group (for example, a code division multiplexing (CDM) group, a reference signal group, a CORESET group, a CORESET pool), a reference signal configuration, a reference signal set configuration, and the like may be interchangeably interpreted.

A panel Identifier (ID) and a panel may be interchangeably interpreted. A TRP ID and a TRP may be interchangeably interpreted. An index and an ID may be interchangeably interpreted.

Note that, in the present disclosure, a group may be interchangeably interpreted as a set, a cluster, a panel, a group related to a beam (to be reported), and the like.

In the following embodiments, a beam index may be interpreted as a CRI/SSBRI, for example. The RSRP/SINR may be interpreted as measurement results related to any beam.

Terms related to the CSI-RS may be interpreted as corresponding terms related to the SSB. For example, CSI-RS resources may be interpreted as SSB resources. In other words, the CSI-RS may be interpreted as the CSI-RS/SSB, and the CRI may be interpreted as the CRI/SSBRI.

In the present disclosure, a “reception panel” may correspond to at least one of an RS group, a TRP index, a CORESET pool index, an RS group configured for a group based beam report, a TCI state (or TCI) group, a QCL assumption (QCL) group, and a beam group.

In the present disclosure, “the same position” may be interpreted as “the same i-th,” “corresponding to the same TRP,” and the like.

### (Radio Communication Method)

### First Embodiment

A first embodiment will describe association between the TRPs and the panels and ordering of groups in an environment of mode 1 of the multiple group based beam report. Note that, in the following embodiments of the present disclosure, description will be given assuming an environment of the configuration shown in FIG. 6. Note that the present embodiment is not limited to mode 1 of the multiple group based beam report, and can also be applied to any environment using the multiple group based beam report as appropriate.

Note that, in the present disclosure, reported beams may be referred to as reported RSs, may mean beams used for transmission from a certain TRP for a CSI-RS/SSB as a report (measurement) target in a certain group, or may mean the CSI-RS/SSB itself.

In the first embodiment described below, in the environment of mode 1 of the multiple group based beam report, it is assumed that reported beams included in one certain group are transmitted from one certain TRP and are received (measured) by one certain UE panel, and reported beams included in another group are transmitted from another different TRP and are received (measured) by another different UE panel.

### Embodiment 1-1

The UE may determine a panel for performing measurement/reporting for each RS configuration (TRP). The determination method is broadly classified into the following three (embodiments 1-1-1, 1-1-2, and 1-1-3).

In embodiment 1-1-1, determination of the panel for performing measurement/reporting corresponding to a certain TRP may be dependent upon implementation of the UE. For example, the UE may determine to use panel #i (i is an integer) for measurement/reporting for TRP #i.

In embodiment 1-1-2, the UE may determine the panel for performing measurement/reporting corresponding to a certain TRP, based on a specific transmit beam (for example, the best transmit beam) out of transmit beams for respective TRPs measured for respective panels.

For example, when measurement results regarding TRP #Y in panel #X are the best out of the measurement results of the RSs regarding each TRP in each panel, the UE may determine that the panel for measurement/reporting corresponding to TRP #Y is panel X. Then, the UE may repeat a process of selecting the best measurement results out of measurement results which are obtained by excluding measurement results related to at least one of panel #X and TRP #Y from measurement results of the RSs regarding each TRP in each panel and then determining the panel for measurement/reporting corresponding to one of the remaining TRPs, until the panels regarding all of the TRPs are determined.

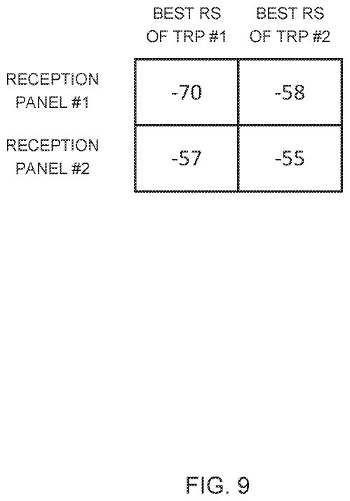

FIG. 9 is a diagram to show an example of measurement results respectively corresponding to the best RSs in respective TRPs and a plurality of reception panels. In the example of FIG. 9, regarding the best RS of TRP #1, measurement results in panel #1 are −70 and measurement results in panel #2 are −57, and regarding the best RS of TRP #2, measurement results in panel #1 are −58 and measurement results in panel #2 are −55. When the UE obtains measurement results as shown in the example of FIG. 9, first, the UE may select panel #2 as the reception panel for performing measurement/reporting of the RS from TRP #2, and then select the remaining panel (panel #1) as the reception panel for performing measurement/reporting of the RS from TRP #1.

In embodiment 1-1-3, the UE may determine the panel corresponding to the TRP, based on the average (or the sum) of all of measurement results regarding combinations of the pairs of the TRPs and the panels (which may be referred to as TRP-panel pairs). For example, a first combination of the TRP-panel pairs may be a combination of a pair {TRP #1, panel #1} and a pair {TRP #2, panel #2}. A second combination of the TRP-panel pairs may be a combination of a pair {TRP #2, panel #1} and a pair {TRP #1, panel #2}.

For example, regarding each combination, the UE may calculate the average of measurement results of all of the TRP-panel pairs, and determine the panel corresponding to the TRP from combinations of the TRP-panel pairs having the best average of measurement results.

When the UE obtains measurement results shown in the example of FIG. 9, the combinations of measurement results of the pair of the TRP and the panel are (−70, −55) corresponding to the first combination described above and (−58, −57) corresponding to the second combination described above. In this case, a combination having the best average measurement results of all of the TRP-panel pairs in the combinations is (−58, −57), and thus the UE determines the panel corresponding to TRP #1 as panel #2 and determines the panel corresponding to TRP #2 as panel #1.

The UE may determine ordering of a plurality of groups in one CSI report, based on at least one of a TRP ID (RS configuration ID), a panel ID, the best (or X-th best (for example, X=2)) measurement value in each group, and the average (sum) of measurement values in each group. For example, the UE may generate the CSI report, with a group having a smaller panel ID as group #1 and a group having a larger panel ID as group #2.

Note that based on which rule the association between the TRPs and the panels is performed (for example, which is employed among embodiments 1-1-1, 1-1-2, and 1-1-3) may be defined in a specification, or may be configured from a NW (a network, for example, the base station) to the UE, using higher layer signaling. Based on which rule the ordering of groups is performed (for example, whether the TRP ID is employed as a basis or the like) may be defined in a specification, or may be configured from a NW (a network, for example, the base station) to the UE, using higher layer signaling.

### [Variation of Embodiment 1-1]

The UE may prioritize a specific TRP (for example, TRP #1, a TRP having the minimum (or maximum) TRP index) to determine the CRI (beam) corresponding to the specific TRP. The UE may determine that the specific TRP invariably belongs to a specific group (for example, group #1).

For example, the UE may first determine the CRI corresponding to the TRP corresponding to the minimum (or maximum) TRP index (CORESET pool index). Then, the UE may determine the CRI corresponding to another TRP.

When determining the CRI corresponding to another TRP, the UE may consider whether or not the UE can simultaneously receive the beam pair corresponding to each TRP. The “beam pair corresponding to each TRP” described herein may mean a pair of beams (CRIs) located at an i-th (i is an integer) position in each group in the report.

The above operation will be described by taking FIG. 7 as an example. The UE first determines the beam (here, CRI #1-1 or CRI #1-3) corresponding to TRP #1, based on the maximum L1-RSRP/L1-SINR (here, RSRP/SINR #1-1 or RSRP/SINR #1-3). Then, the UE determines the beam (here, CRI #2-2 or CRI #2-3) corresponding to TRP #2, based on the maximum L1-RSRP/L1-SINR (here, RSRP/SINR #2-2 or RSRP/SINR #2-3). When determining the beam corresponding to TRP #2, the UE considers whether or not the UE can simultaneously receive the beam pair (in this case, CRI #1-1 and CRI #2-2, or CRI #1-3 and CRI #2-3) corresponding to each TRP, and performs control to select the beam that can be received simultaneously with the beam of TRP #1. For example, the UE may determine a first CRI of group #2 among CRIs (specifically, CRIs #2-1 to #2-4) that can be received simultaneously with a first CRI (CRI #1-1) of group #1.

Note that, in the present disclosure, the TRP index (CORESET pool index) may correspond to at least one of an RS group, a reception panel, an RS group configured for a group based beam report, a TCI state (or TCI) group, a QCL assumption (or QCL) group, and a beam group.

### Embodiment 1-2

The UE need not perform determination of the panel for measurement/reporting. The UE may implicitly/explicitly report the panel ID in order to report measurement results corresponding to a plurality of (for example, all of) combinations of the TRP and the panel. The following will describe a case in which the number of groups is 4, but this is not restrictive.

When the UE implicitly reports the panel ID, ordering of a plurality of groups may be based on at least one of the panel ID and the TRP ID. For example, when the UE implicitly reports the panel ID, every certain number (for example, two) of panel IDs may correspond to every certain number (for example, two) of group IDs in ascending order. Group #{i+N(j−1)} may correspond to panel #j, where the number of TRPs is represented by M (for example, 2), the number of panels is represented by N (for example, 2), the TRP ID is represented by i (i=1, . . . , M), and the panel ID is represented by j (j=1, . . . , N). For example, groups #1 and #2 may correspond to panel #1, and groups #3 and #4 may correspond to panel #2. For example, when the UE implicitly reports the panel ID, in ascending order from the smallest TRP ID, the panel IDs respectively corresponding to the TRP IDs may be ordered in ascending order. For example, group #{M(i−1)+j} may correspond to panel #j.

In other words, at least one of the panel ID and the TRP ID may be associated with a group (for example, based on the group ID).

Note that, in the present disclosure, “small” may be replaced with “large,” and “ascending order” may be replaced with “descending order.”

In contrast, when the UE explicitly reports the panel ID, the panel ID for each group may be reported. The panel ID may be an RS ID, an RS set ID, or a specific ID introduced in Rel. 17 or later versions. The UE may receive reporting of the panel ID, which is included in the CSI report in such a manner that correspondence with the CRI (or measurement results of the CRI) or the group is explicit. The UE may transmit, to the network, the panel ID related to a certain CSI report (or a certain group of the CSI report), separately from the CSI report (for example, using higher layer signaling, physical layer signaling, or a specific channel/signal).

In this case, regarding ordering of a plurality of groups for one CSI report, the UE may perform the ordering, based on at least one of a TRP ID, an RS configuration ID, a panel ID, the best (or X-th best (for example, X=2)) measurement value in each group, and the average (sum) of measurement values in each group.

Note that, regarding the specific ID introduced in Rel. 17 or later versions, the UE may be capable of simultaneously receiving the RSs reported (or transmitted) from the plurality of groups having different specific IDs. The UE need not be capable of simultaneously receiving the RSs reported from the group having the same specific ID.

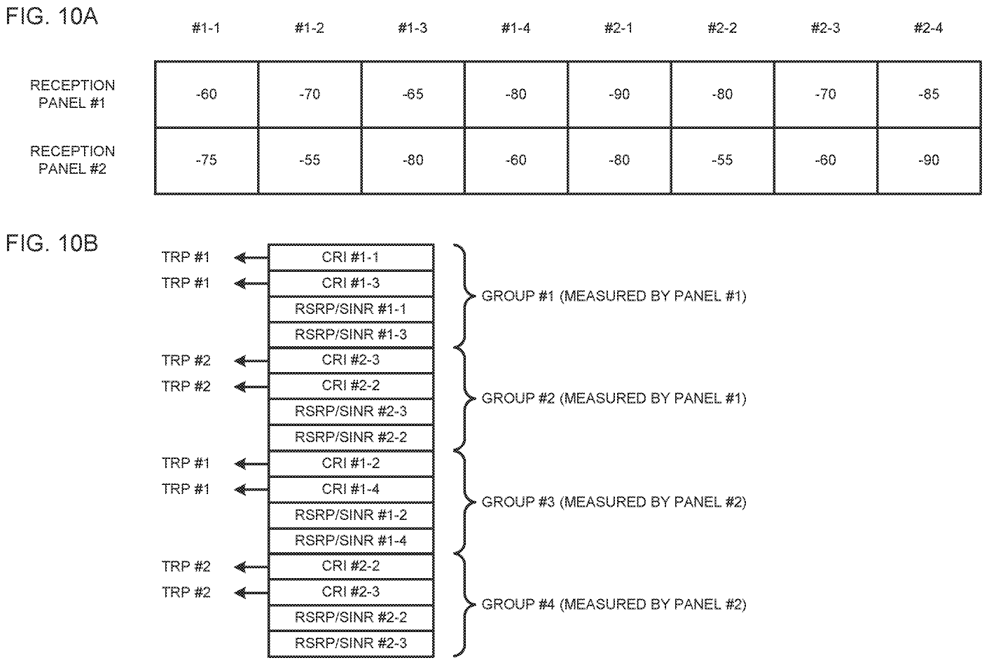

FIGS. 10A and 10B are each a diagram to show an example in which mode 1 of the multiple group based beam report according to embodiment 1-2 is applied. FIGS. 10A and 10B each show an example of ordering of a plurality of groups when the UE implicitly reports the panel ID.

FIG. 10B shows an example of the CSI report reported by the UE when the number of groups is 4. In the example of FIG. 10B, the UE determines that first and second best CRIs (CRI #1-1 and CRI #1-3) from TRP #1 measured by panel #1 and measurement results (RSRP/SINR #1-1 and RSRP/SINR #1-3) corresponding to the first and second best CRIs are for group #1. The UE determines that first and second best CRIs (CRI #2-3 and CRI #2-2) from TRP #2 measured by panel #1 and measurement results (RSRP/SINR #2-3 and RSRP/SINR #2-2) corresponding to the first and second best CRIs are for group #2. The UE determines that first and second best CRIs (CRI #1-2 and CRI #1-4) from TRP #1 measured by panel #2 and measurement results (RSRP/SINR #1-2 and RSRP/SINR #1-4) corresponding to the first and second best CRIs are for group #3. The UE determines that first and second best CRIs (CRI #2-2 and CRI #2-3) from TRP #2 measured by panel #2 and measurement results (RSRP/SINR #2-2 and RSRP/SINR #2-3) corresponding to the first and second best CRIs are for group #4.

Note that, when all of the TRP-panel pairs are reported on one CSI report using a plurality of groups as shown in FIG. 10B, the UE need not assume that the UE can necessarily simultaneously receive a plurality of beams that belong to different groups (may assume that the UE can simultaneously receive a plurality of beams that belong to different groups and are received by different panels). The CSI report need not correspond to mode 1.

Whether or not such panel-specific (panel specific) measurement/reporting as the measurement/reporting performed by a plurality of panels included in one CSI report as described in embodiment 1-2 is used may be defined in a specification in advance, or may be configured for the UE by using higher layer signaling.

### Embodiment 1-3

The UE may perform selection (determination)/ordering of beam indices included in each group, based on measurement results of received quality (for example, L1-RSRP/L1-SINR) of each beam.

For example, the UE may perform selection (determination)/ordering of beam indices included in each group, based on maximum measurement results of L1-RSRP/L1-SINR out of measurement results of L1-RSRP/L1-SINR of each beam.

According to the first embodiment described above, in the environment of mode 1 of the multiple group based beam report, association between the TRPs and the panels and ordering of groups can be appropriately performed, and therefore flexibility of scheduling by the base station can be further enhanced.

### Second Embodiment

A second embodiment will describe association between the TRPs and the panels and ordering of groups in an environment of mode 2 of the multiple group based beam report. Note that the present embodiment is not limited to mode 2 of the multiple group based beam report, and can also be applied to any environment using the multiple group based beam report as appropriate.

In the second embodiment described below, in the environment of mode 2 of the multiple group based beam report, it is assumed that reported beams included in one certain group are transmitted from a plurality of different TRPs and are received (measured) by a plurality of different UE panels.

### Embodiment 2-1

In embodiment 2-1, regarding determination of the panel for each group included in a certain CSI report, the panel selected for a certain TRP may be different in a plurality of different groups (embodiment 2-1-1).

For example, when panel #1 is used for measurement/reporting related to TRP #1 and panel #2 is used for measurement/reporting related to TRP #2 regarding group #1, panel #2 may be used for measurement/reporting related to TRP #1 and panel #1 may be used for measurement/reporting related to TRP #2 regarding group #2.

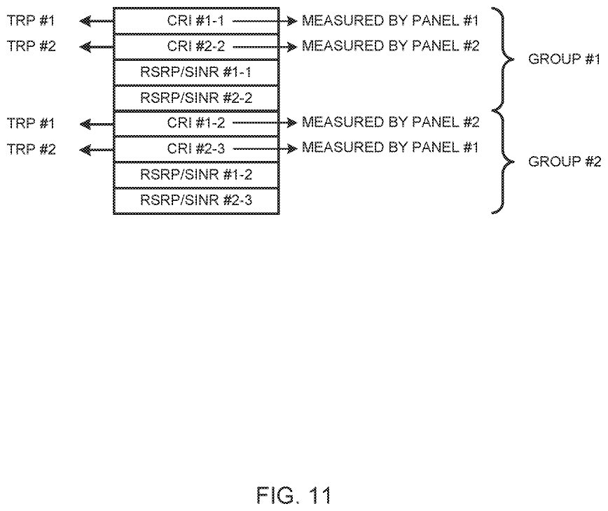

FIG. 11 is a diagram to show an example of the CSI report of mode 2 of the multiple group based beam report according to embodiment 2-1. In the example shown in FIG. 11, when panel #1 is used for measurement/reporting of CRI #1-1 related to TRP #1 included in group #1 and panel #2 is used for measurement/reporting of CRI #2-2 related to TRP #2, panel #2 is used for measurement/reporting of CRI #1-2 related to TRP #1 included in group #2 and panel #1 is used for measurement/reporting of CRI #2-3 related to TRP #2.

In embodiment 2-1-1, for each group, the UE may determine the panel corresponding to each TRP in accordance with embodiment 1-1 described above.

In this case, with respect to the CSI report regarding L1-SINR, for determination of the panels for measurement/reporting of embodiment 1-1, a condition of measurement of received quality (for example, L1-SINR) may be added. For example, when the UE obtains measurement results of a plurality of (for example, two) beams included in a certain group/the average of the measurement results/the sum of the measurement results, the UE may consider interference between the beams between the plurality of reported RSs.

Regarding determination of a panel for each group included in a certain CSI report, a panel selected for a certain TRP may be the same (common) in a plurality of different groups (embodiment 2-1-2).

For example, when panel #1 is used for measurement/reporting related to TRP #1 and panel #2 is used for measurement/reporting related to TRP #2 regarding group #1, panel #1 may be used for measurement/reporting related to TRP #1 and panel #2 may be used for measurement/reporting related to TRP #2 regarding group #2 as well.

In embodiment 2-1-2, the UE may determine the panel corresponding to each TRP in accordance with embodiment 1-1 described above.

In this case, with respect to the CSI report regarding L1-SINR, for determination of the panels for measurement/reporting of embodiment 1-1, a condition of measurement of received quality (for example, L1-SINR) may be added. For example, when the UE obtains measurement results of a plurality of (for example, two) beams included in a certain group/the average of the measurement results/the sum of the measurement results, the UE may consider interference between the beams between the plurality of reported RSs.

The UE may determine ordering of a plurality of groups in one CSI report, based on at least one of a TRP ID (RS configuration ID), a panel ID, the best (or X-th best (for example, X=2)) measurement value in each group, and the average (sum) of measurement values in each group.

Note that based on which rule the association between the TRPs and the panels is performed (for example, which is employed among embodiments 2-1-1 and 2-1-2) may be defined in a specification, or may be configured from a NW (a network, for example, the base station) to the UE, using higher layer signaling. Based on which rule the ordering of groups is performed (for example, whether the TRP ID is employed as a basis or the like) may be defined in a specification, or may be configured from a NW (a network, for example, the base station) to the UE, using higher layer signaling.

### Embodiment 2-2

Regarding ordering of beams in each group, the UE may apply the same ordering rule to a plurality of different groups.

For example, the UE may perform ordering of beams in each group, based on the measurement values of the L1-RSRP/L1-SINR related to a plurality of (for example, two) beams included in one group. For example, the UE may perform ordering of beams in each group, based on the panel IDs included in one group. In other words, when a first CRI in a certain group is related to panel ID=1 and a second CRI therein is related to panel ID=2, the CSI report may be generated such that a first CRI in another group is related to panel ID=1 and a second CRI therein is related to panel ID=2. For example, the UE may perform ordering of beams in each group, based on the TRP IDs included in one group.

Note that ordering of beams included in a certain group may be defined in a specification in advance, or may be configured from the NW using higher layer signaling.

### Third Embodiment

Embodiment 1-1 and embodiment 1-2 described above may be applied in an environment in which the group based beam report is not used (an environment in which non-group based beam report is used).

In the environment in which the non-group based beam report is used, the higher layer parameter (for example, CSI-ReportConfig) for CSI report configuration may be associated with one TRP. In other words, the higher layer parameter for CSI report configuration may include resources for channel measurement corresponding only to one TRP. In this case, a certain CSI report corresponding to a certain TRP and another CSI report corresponding to another TRP may be associated. In this case, the beam indices reported on each CSI report may be determined based on whether or not the beam indices can be simultaneously received by a plurality of different panels of the UE.

In such a case, for example, in order to determine the panels used for measurement/reporting of each CSI report, the UE may apply at least one of the rule of association between the TRPs and the panels and the rule of ordering of a plurality of groups described in embodiment 1-1. In this case, the “group” in the description of embodiment 1-1 may be replaced with the “CSI report” (in other words, a plurality of groups in one CSI report may correspond to a plurality of CSI reports). Specifically, for example, the UE may determine to use panel #1 for CSI report #1 and use panel #2 for CSI report #2.

Note that based on which rule the association between the TRPs and the panels is performed (for example, which is employed among embodiments 1-1-1, 1-1-2, and 1-1-3) may be defined in a specification, or may be configured from a NW (a network, for example, the base station) to the UE, using higher layer signaling. Based on which rule the ordering of groups is performed (for example, whether the TRP ID is employed as a basis or the like) may be defined in a specification, or may be configured from a NW (a network, for example, the base station) to the UE, using higher layer signaling.

In such a case, for example, in order to determine the panels used for measurement/reporting of each CSI report, the UE may apply at least one of the rule of association between the TRPs and the panels and the rule of ordering of a plurality of groups described in embodiment 2-1. In this case, the “group” in the description of embodiment 2-1 may be replaced with the “CSI report” (in other words, a plurality of groups in one CSI report may correspond to a plurality of CSI reports). For example, for one CSI report, the UE may use each panel for measurement of resources for channel measurement for one TRP, or may use each panel for reporting of a plurality of measurement results. Specifically, for example, regarding CSI report #1 of TRP #1, the UE may report the L1-RSRP/L1-SINR measured by panel #1 and panel #2, and regarding CSI report #1 of TRP #2, the UE may report the L1-RSRP/L1-SINR measured by panel #1 and panel #2.

In this case, the UE may consider the panel ID explicitly reported/the specific ID introduced in Rel. 17 or later versions. In this case, the UE may consider the panel ID implicitly reported.

Note that, regarding the specific ID introduced in Rel. 17 or later versions, the UE may be capable of simultaneously receiving the RSs reported (or transmitted) from the plurality of groups having different specific IDs. The UE need not be capable of simultaneously receiving the RSs reported from the group having the same specific ID.

Whether or not such panel-specific (panel specific) measurement/reporting as the measurement/reporting performed by a plurality of panels included in one CSI report is used may be defined in a specification in advance, or may be configured to UE using higher layer signaling.

Note that, in such a case, association between a plurality of (for example, two) CSI reports need not be configured. In this case, the NW can obtain measurement results by a plurality of (for example, two) panels for each TRP/RS configuration, and the NW can perform appropriate scheduling taking both of transmission of the TRP and reception of the UE into consideration.

### <Additional Notes>

In the present disclosure, whether or not the UE supports/uses the method of determining (selecting) the beam/panel based on the average/sum of measurement results of a plurality of beams in each group may be based on a report of UE capability information, or may be configured by higher layer signaling (for example, RRC signaling).

In the present disclosure, whether or not a report of L1-RSRP/L1-SINR measurement using a plurality of different UE panels is supported/used in one CSI report in the group based beam report/non-group based beam report may be based on a report of UE capability information, or may be configured by higher layer signaling (for example, RRC signaling). In this case, information related to the number of panels for panel specific measurement/reporting may be included in one CSI report.

In the present disclosure, whether or not consideration of interference between beams between a plurality of (for example, two) resources for channel measurement for a plurality of reported beams in one group is supported/used regarding the L1-SINR (for example, in a case as in mode 2) may be based on a report of UE capability information, or may be configured by higher layer signaling (for example, RRC signaling).

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

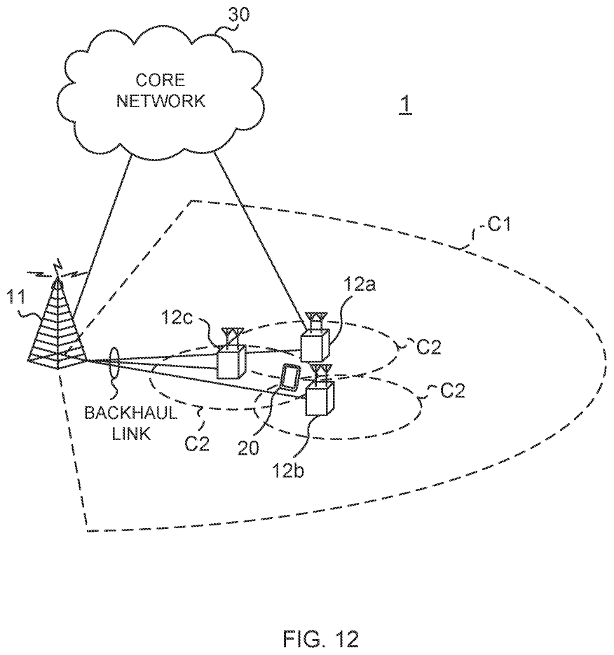

FIG. 12 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations (for example, RRHs) 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

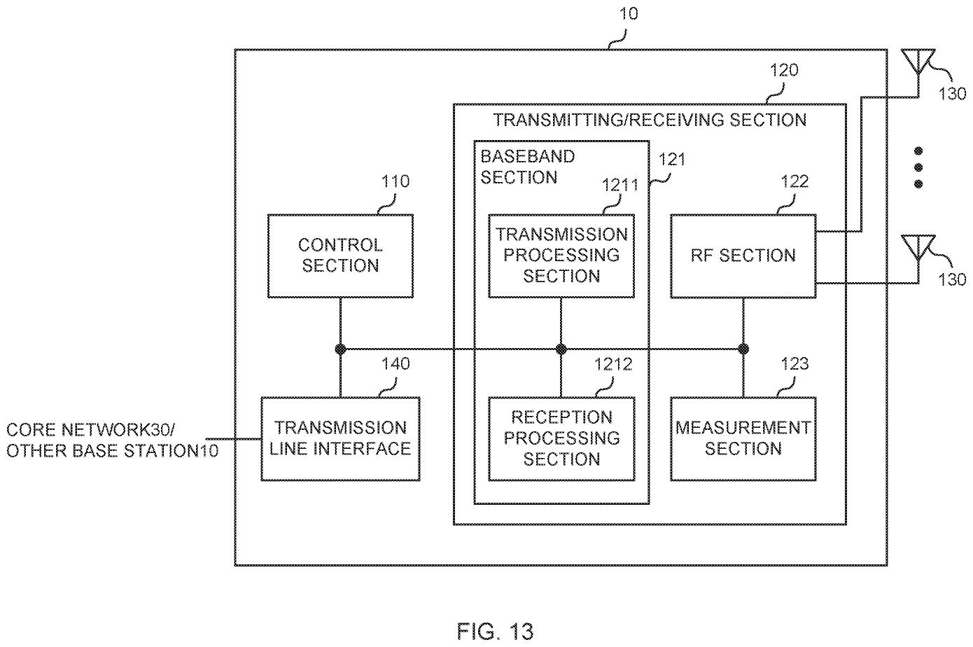

FIG. 13 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

The transmitting/receiving section 120 may transmit signals (which may be reference signals (for example, CSI-RSs or SSBs)) to a terminal in a plurality of resources. The control section 110 may control reception of a channel state information (CSI) report, regarding the CSI report including a plurality of resource indicators corresponding to at least two of the plurality of resources and measurement results respectively corresponding to the plurality of resource indicators, at which position in the CSI report each of the plurality of resource indicators regarding which panel is to be included being determined by the terminal for a group, based on whether or not the signals for the plurality of resource indicators corresponding to a same group can be simultaneously received and the measurement results for each panel, the CSI report being transmitted by the terminal (first to third embodiments).

### (User Terminal)

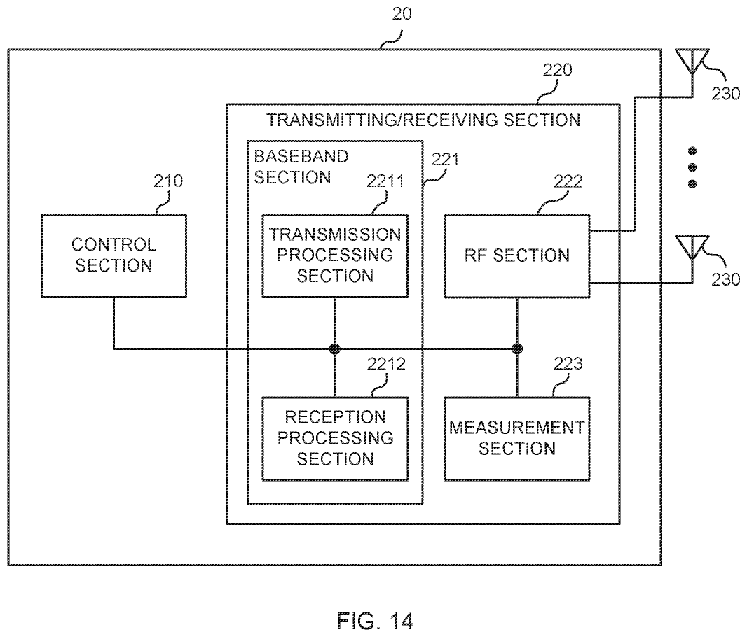

FIG. 14 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The control section 210 may determine, for a group, regarding a channel state information (CSI) report including a plurality of resource indicators and measurement results respectively corresponding to the plurality of resource indicators, at which position in the CSI report each of the resource indicators regarding which panel is to be included, based on whether or not signals (which may be reference signals (for example, CSI-RSs or SSBs)) for the plurality of resource indicators corresponding to a same group can be simultaneously received and the measurement results for each panel. The transmitting/receiving section 220 may transmit the CSI report (first to third embodiments).

When the signals cannot be simultaneously received, the control section 210 may perform control to report information (for example, a panel ID) related to the panel corresponding to the group including the plurality of resource indicators (embodiment 1-2).

When the signals can be simultaneously received, the control section 210 may determine that the resource indicators at a same position in different groups included in the CSI report correspond to different panels (embodiment 2-1).

When the signals can be simultaneously received, the control section 210 may determine that the resource indicators at a same position in different groups included in the CSI report correspond to a same panel (embodiment 2-1).

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

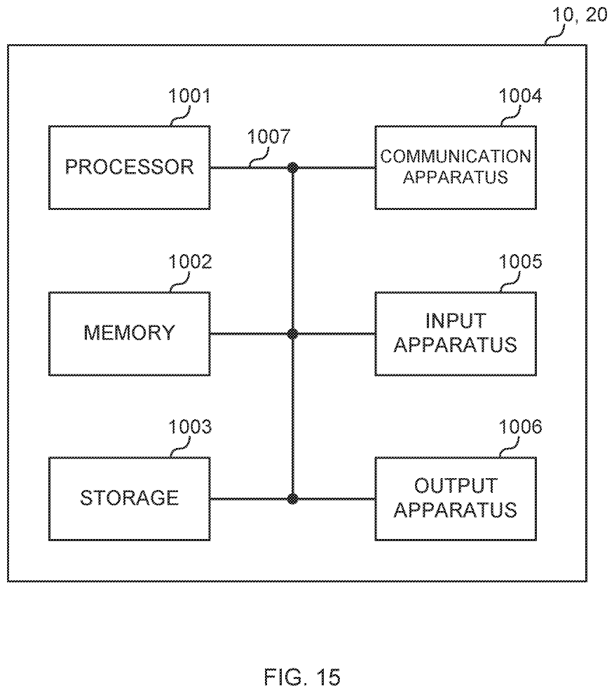

For example, a base station, a user terminal, and so on according to one embodiment of the present disclosure may function as a computer that executes the processes of the radio communication method of the present disclosure. FIG. 15 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be device mounted on a mobile body or a mobile body itself, and so on. The mobile body may be a vehicle (for example, a car, an airplane, and the like), may be a mobile body which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor, and the like.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “side”). For example, an uplink channel, a downlink channel and so on may be interpreted as a side channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG) (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a control section that determines, for a group, regarding a channel state information (CSI) report including a plurality of resource indicators and measurement results respectively corresponding to the plurality of resource indicators, at which position in the CSI report each of the resource indicators regarding which panel is to be included, based on whether or not signals for the plurality of resource indicators corresponding to a same group can be simultaneously received and the measurement results for each panel; and
a transmitting section that transmits the CSI report.

2. The terminal according to claim 1, wherein
when the signals cannot be simultaneously received, the control section performs control to report information related to the panel corresponding to the group including the plurality of resource indicators.

3. The terminal according to claim 1, wherein
when the signals can be simultaneously received, the control section determines that the resource indicators at a same position in different groups included in the CSI report correspond to different panels.

4. The terminal according to claim 1, wherein
when the signals can be simultaneously received, the control section determines that the resource indicators at a same position in different groups included in the CSI report correspond to a same panel.

5. A radio communication method for a terminal, the radio communication method comprising the steps of:
determining, for a group, regarding a channel state information (CSI) report including a plurality of resource indicators and measurement results respectively corresponding to the plurality of resource indicators, at which position in the CSI report each of the resource indicators regarding which panel is to be included, based on whether or not signals for the plurality of resource indicators corresponding to a same group can be simultaneously received and the measurement results for each panel; and
transmitting the CSI report.

6. A base station comprising:
a transmitting section that transmits signals to a terminal in a plurality of resources; and
a control section that controls reception of a channel state information (CSI) report, regarding the CSI report including a plurality of resource indicators corresponding to at least two of the plurality of resources and measurement results respectively corresponding to the plurality of resource indicators, at which position in the CSI report each of the plurality of resource indicators regarding which panel is to be included being determined by the terminal for a group, based on whether or not the signals for the plurality of resource indicators corresponding to a same group can be simultaneously received and the measurement results for each panel, the CSI report being transmitted by the terminal.
